(19) United States
(12) Patent Application Publication
(10) Pub. No.: US 2011/0080643 A1
(43) Pub. Date: Apr. 7, 2011

(54) HARD-COATED ANTIGLARE FILM, POLARIZING PLATE AND IMAGE DISPLAY INCLUDING THE SAME, AND METHOD FOR EVALUATING THE SAME

(75) Inventors: Teppei Niinou, Ibaraki-shi (JP); Daisuke Hamamoto, Ibaraki-shi (JP)

(73) Assignee: NITTO DENKO CORPORATION, Osaka (JP)

(21) Appl. No.: 12/899,969

(22) Filed: Oct. 7, 2010

(30) Foreign Application Priority Data
Oct. 7, 2009 (JP) 2009-233940

(51) Int. Cl. G02B 5/02; G02B 1/10; G02B 1/04; G01N 21/47

(52) U.S. Cl. 359/599; 356/446

(57) ABSTRACT

A hard-coated antiglare film that has superior antiglare properties, and reflection properties even when a haze value is low, and can improve the depth of black in black display by preventing “tinting” occurs specifically when a reflection is reduced, a polarizing plate, and the like. The film has a reflection intensity ratio of 3 or less, a hard-coating antiglare layer containing fine particles, and an antireflection layer. A surface of the antireflection layer has an uneven shape, and an average angle of inclination θa and an arithmetic average surface roughness Ra in predetermined ranges. At the surface of the antireflection layer, convexities exceeding a roughness mean line of a surface roughness profile in a predetermined number range, and convexities exceeding a standard line that is in parallel with the mean line and is located at a height of 0.1 μm in predetermined size and number ranges are included.

### CROSS-REFERENCE TO RELATED APPLICATION

This application claims priority from Japanese Patent Application No. 2009-233940 filed on Oct. 7, 2009. The entire subject matter of the Japanese Patent Application is incorporated herein by reference.

### BACKGROUND OF THE INVENTION

1. Field of the Invention

The present invention relates to a hard-coated antiglare film, a polarizing plate and an image display including the same, and a method for evaluating the same.

2. Description of Related Art

With technical improvements in recent years, liquid crystal displays (LCDs), plasma display panels (PDPs), electroluminescence displays (ELDs), and the like have been developed in addition to conventional cathode ray tube (CRT) displays as image displays and have been used in practical applications. Particularly, with technical innovations of LCDs with respect to, for example, wide viewing angles, high resolution, high response, and superior color reproduction, applications of LCDs have been expanded to mobile phones and also vehicle-mounted devices such as monitors for a car navigation system and the like. In these applications, it is required to further improve visibility. One of the causes by which sufficient visibility cannot be obtained is interface reflection at the interface between polarizing plate disposed on the topmost surface of display and air. Therefore, in order to further improve visibility, a method in which low reflection treatment is carried out to a surface of a polarizing plate (for instance, see JP 11(1999)-295503 A, and JP2002-122705 A) generally is used.

Further, in order to prevent a decrease in contrast caused by a reflection of external light, there is a method in which antiglare treatment is carried out. For the antiglare treatment, a hard-coated antiglare film can be used (for instance, see JP2008-90263 A). Even in the case where a hard-coated antiglare film is used, carrying out low reflection treatment to the film has been studied for the sake of further improving visibility from the viewpoint of antireflection (for instance, see JP2006-317957 A), and it is also important to maintain antiglare properties after providing the film with low reflection properties. Meanwhile, in recent years, lowering a haze value of the hard-coated antiglare film is being required for the sake of increasing the contrast. When a haze value of the hard-coated antiglare film is lowered, variations in brightness in pixels are emphasized which cause a visible failure (a failure due to glare) and result in considerably deteriorated image quality.

### SUMMARY OF THE INVENTION

The hard-coated antiglare film of the present invention has a reflection intensity ratio of 3 or less, includes a transparent plastic film substrate, and includes a hard-coating antiglare layer and an antireflection layer, which are on at least one surface of a transparent plastic film substrate. The hard-coating antiglare layer contains fine particles. A surface of the antireflection layer has an uneven shape and has an average angle of inclination θa satisfying 0.5≦θa≦1.5, and the following arithmetic average surface roughness Ra in the range of 0.05 to 0.15 μm. The hard-coated antiglare film includes at least 80 convexities that exceed a roughness mean line of a surface roughness profile in a 4-mm long portion at an arbitrary location of the surface of the antireflection layer, convexities that exceed a standard line that is parallel with the roughness mean line and is located at a height of 0.1 μm, and no convexities in which line segments of portions of the standard line that cross the convexities each have a length of 50 μm or longer.

Reflection intensity ratio:a ratio of a reflection intensity obtained when light is applied to the hard-coated antiglare film at an angle of 10° with a direction perpendicular to the hard-coated antiglare film so that a light intensity of the topmost surface of the hard-coated antiglare film becomes 1000 Lx assuming that a reflection intensity of a hard-coated film with a refractive index of 1.53 is 1.

Ra: an arithmetic average surface roughness (μm) that is defined in JIS B 0601 (1994 version).

The polarizing plate of the present invention includes the hard-coated antiglare film of the present invention and a polarizer.

The image display of the present invention includes the hard-coated antiglare film of the present invention.

The image display of the present invention includes the polarizing plate of the present invention.

The hard-coated antiglare film evaluating method of the present invention is a method for evaluating a hard-coated antiglare film, including: evaluating visibility of a hard-coated antiglare film using: a following reflection intensity ratio; an average angle of inclination θa of an uneven shape on a surface of the hard-coated antiglare film; a following arithmetic average surface roughness Ra; the number of convexities that exceed a roughness mean line of a surface roughness profile in a 4-mm long portion at an arbitrary location of the surface of the hard-coated antiglare film; and a size and the number of convexities that exceed a standard line that is in parallel with the roughness mean line and is located at a height of 0.1 μm.

Reflection intensity ratio:a ratio of a reflection intensity obtained when light is applied to the hard-coated antiglare film at an angle of 10° with a direction perpendicular to the hard-coated antiglare film so that a light intensity of the topmost surface of the hard-coated antiglare film becomes 1000 Lx assuming that a reflection intensity of a hard-coated film with a refractive index of 1.53 is 1.

Ra: an arithmetic average surface roughness (μm) that is defined in JIS B 0601 (1994 version).

The hard coated antiglare film of the present invention can have low reflection properties. Further, by realizing a specific uneven shape, the film can have superior antiglare properties and can suppress glare from occurring while “tinting” occurs at the time when a reflection of the film is reduced, and a haze value in the film can be reduced. Thus, visibility can be improved as compared with that of a conventional low reflection hard-coated antiglare film. Furthermore, by preventing “tinting” from occurring, the depth of black in black display of an image display can be improved. Thus, the image display including the hard-coated antiglare film or the polarizing plate of the present invention has superior display properties.

### BRIEF DESCRIPTION OF THE DRAWINGS

FIG. 1(a) is a diagram showing a profile, which indicates a range of 0 to 1 mm out of a measured length of 4 mm, of a sectional surface shape of a hard-coated antiglare film according to Example 1.

FIG. 1(b) is a diagram showing a profile, which indicates a range of 1 to 2 mm out of a measured length of 4 mm, of the sectional surface shape of the hard-coated antiglare film according to Example 1.

FIG. 1(c) is a diagram showing a profile, which indicates a range of 2 to 3 mm out of a measured length of 4 mm, of the sectional surface shape of the hard-coated antiglare film according to Example 1.

FIG. 1(d) is a diagram showing a profile, which indicates a range of 3 to 4 mm out of a measured length of 4 mm, of the sectional surface shape of the hard-coated antiglare film according to Example 1.

FIGS. 2(a) to (d) are diagrams showing profiles that indicate a measured length of 4 mm of a sectional surface shape of a hard-coated antiglare film according to Example 2; (a) a range of 0 to 1 mm, (b) a range of 1 to 2 mm, (c) a range of 2 to 3 mm, and (d) a range of 3 to 4 mm.

FIGS. 3(a) to (d) are diagrams showing profiles that indicate a measured length of 4 mm of a sectional surface shape of a hard-coated antiglare film according to Example 3; (a) a range of 0 to 1 mm, (b) a range of 1 to 2 mm, (c) a range of 2 to 3 mm, and (d) a range of 3 to 4 mm.

FIG. 4 is a diagram showing a profile that indicates a range of 2 to 3 mm out of a measured length of 4 mm, of a sectional surface shape of a hard-coated antiglare film according to Comparative Example 1.

FIG. 5 is a diagram showing a profile that indicates a range of 0 to 1 mm out of a measured length of 4 mm of a sectional surface shape of a hard-coated antiglare film according to Comparative Example 2.

FIG. 6 is a diagram showing a profile that indicates a range of 0 to 1 mm out of a measured length of 4 mm, of a sectional surface shape of a hard-coated antiglare film according to Comparative Example 3.

FIG. 7 is a diagram showing a profile that indicates a range of 0 to 1 mm out of a measured length of 4 mm, of a sectional surface shape of a hard-coated antiglare film according to Comparative Example 4.

FIG. 8 is a diagram showing a profile that indicates a range of 0 to 1 mm out of a measured length of 4 mm, of a sectional surface shape of a low reflection hard-coated film according to Comparative Example 5.

FIG. 9 is a schematic drawing showing an example of a relationship among a roughness curve, a height h, and a standard length L.

FIG. 10 is a schematic drawing for explaining a method for measuring the number of convexities that exceed the roughness mean line of the surface roughness profile in the present invention.

FIG. 11 is a schematic drawing for explaining a method for measuring the number of convexities that exceed the standard line in the present invention.

### DETAILED DESCRIPTION OF THE INVENTION

Preferably, in the hard-coated antiglare film of the present invention, the antireflection layer has a thickness in a range of 170 to 350 nm.

Preferably, in the hard-coated antiglare film of the present invention, a haze value is in a range of 4 to 30.

Preferably, in the hard-coated antiglare film of the present invention, the hard-coating antiglare layer is formed using the fine particles and a material for forming a hard-coating layer, which contains the following components (A) and (B):

the component (A): a curable compound having at least one of an acrylate group and a methacrylate group, and

the component (B): particles with a weight average particle size of 200 nm or less, which are formed by binding between inorganic oxide particles and an organic compound having a polymerizable unsaturated group.

Preferably, in the component (B), the inorganic oxide particles include particles of at least one type selected from the group consisting of silicon oxide, titanium oxide, aluminum oxide, zinc oxide, tin oxide, and zirconium oxide.

Preferably, the material for forming a hard-coating layer contains the component (B) in the range of 100 to 200 parts by weight per 100 parts by weight of the component (A).

Preferably, the difference in refractive index between the material for forming a hard-coating layer and the fine particles is in the range of 0.01 to 0.04, at least one type of spherical and amorphous fine particles, each of which have a weight average particle size in the range of 0.5 to 8 μm, are contained as the fine particles, and the fine particles are contained in the range of 5 to 20 parts by weight per 100 parts by weight of the material for forming a hard-coating layer.

Preferably, in the hard-coated antiglare film of the present invention, the hard-coating antiglare layer has a thickness in the range that is 1.2 to 3 times the weight average particle size of the fine particles.

Preferably, in the hard-coated antiglare film evaluating method of the present invention, the hard-coated antiglare film is evaluated as acceptable when the reflection intensity ratio is 3 or less, the θa satisfies 0.5≦θa≦1.5, the Ra is in a range of 0.05 to 0.15 μm, and the hard-coated antiglare film includes at least 80 convexities that exceed the roughness mean line and no convexities in which line segments of portions of the standard line that cross the convexities each have a length of 50 μm or longer.

Preferably, the hard-coated antiglare film evaluating method of the present invention include further evaluating visibility of the hard-coated antiglare film using a haze value of the hard-coated antiglare film.

Preferably, in the hard-coated antiglare film evaluating method of the present invention, when the haze value is in a range of 4 to 30, the hard-coated antiglare film is evaluated as acceptable.

Next, the present invention is described in detail. The present invention, however, is not limited by the following description.

The hard-coated antiglare film of the present invention includes a transparent plastic film substrate and a hard-coating antiglare layer that is on at least one surface of the transparent plastic film substrate.

The transparent plastic film substrate is not particularly limited. Preferably, the transparent plastic film substrate has a high visible light transmittance (preferably a light transmittance of at least 90%) and superior transparency (preferably a haze value of 1% or lower). Examples of the transparent plastic film substrate include those described in JP 2008-90263 A. As the transparent plastic film substrate, those having small optical birefringence are used suitably. The hard-coated antiglare film of the present invention can be used, for example, as a protective film for a polarizing plate. In this case, the transparent plastic film substrate preferably is a film formed of triacetylcellulose (TAC), polycarbonate, an acrylic polymer, or a polyolefin having a cyclic or norbornene structure. In the present invention, as described below, the transparent plastic film substrate may be a polarizer itself. Such a structure does not need a protective layer formed of, for example, TAC and simplifies the structure of the polarizing plate. Accordingly, such a structure makes it possible to reduce the number of steps of producing polarizing plates or image displays and to increase production efficiency. In addition, such a structure allows polarizing plates to be formed of thinner layers. When the transparent plastic film substrate is a polarizer, the hard-coating antiglare layer serves as a conventional protective layer. In such a structure, the hard-coated antiglare film also functions as a cover plate in the case where it is attached to the surface of a liquid crystal cell, for example.

In the present invention, the thickness of the transparent plastic film substrate is not particularly limited. For example, the thickness is preferably in the range of 10 to 500 μm, more preferably in the range of 20 to 300 μm, and most suitably in the range of 30 to 200 μm, with consideration given to strength, workability such as handling properties, and thin layer properties. The refractive index of the transparent plastic film substrate is not particularly limited. The refractive index is, for example, in the range of 1.30 to 1.80, preferably in the range of 1.40 to 1.70.

The hard-coating antiglare layer is formed using the fine particles and the material for forming a hard-coating layer. Examples of the material for forming a hard-coating layer include thermosetting resins and ionizing radiation curable resins that are cured with ultraviolet rays or light. It also is possible to use, for example, a commercially available thermosetting resin or an ultraviolet curable resin as the material for forming a hard-coating layer. Preferably, however, the material for forming a hard-coating layer contains, for example, the following components (A) and (B).

Component (A): a curable compound having at least one of an acrylate group and a methacrylate group.

Component (B): particles with a weight average particle size of 200 nm or shorter, which are formed by binding between inorganic oxide particles and an organic compound having a polymerizable unsaturated group.

A curable compound having at least one of an acrylate group and a methacrylate group, which is cured by, for example, heat, light (for instance, ultraviolet light), or an electron beam can be used as the component (A). Examples of the component (A) include silicone resins, polyester resins, polyether resins, epoxy resins, urethane resins, alkyd resins, spiroacetal resins, polybutadiene resins, polythiolpolyene resins, and an oligomer or a prepolymer of, for example, acrylate or methacrylate of a polyfunctional compound such as polyhydric alcohol. These may be used alone or in a combination of two or more of them.

For example, a reactive diluent having at least one of an acrylate group and a methacrylate group also can be used as the component (A). As the reactive diluent, those described in JP 2008-88309 A can be used, for example. Examples of the reactive diluent include monofunctional acrylate, monofunctional methacrylate, polyfunctional acrylate, and polyfunctional methacrylate. The reactive diluent preferably is trifunctional or higher-functional acrylate, or trifunctional or higher-functional methacrylate. This is because it allows the hard-coating antiglare layer to have higher hardness. Examples of the component (A) include butanediol glycerol ether diacrylate, isocyanurate acrylate, and isocyanurate methacrylate. For the component (A), one type can be used independently, or two types or more can be used in combination.

The component (B) is as described above. In the component (B), the inorganic oxide particles can be fine particles of, for example, silicon oxide (silica), titanium oxide, aluminum oxide, zinc oxide, tin oxide, or zirconium oxide. Particularly, fine particles of silicon oxide (silica), titanium oxide, aluminum oxide, zinc oxide, tin oxide, and zirconium oxide are preferable. These may be used alone or in a combination of two or more of them.

In the hard-coated antiglare film of the present invention, in terms of prevention of scattering of light, prevention of a decrease in transmittance of a hard-coating layer, prevention of coloring, and transparency, the component (B) preferably is nanoparticles with weight average particle size in the range of 1 to 200 nm. The weight average particle size can be measured by the method described below in the examples. The weight average particle size more preferably is in the range of 1 to 100 nm. The inventors of the present invention found out that when the component (B), nanoparticles, was added to the component (A), the movement of the fine particles was changed during applying and drying steps according to, for example, the selection of the solvent described below. In other words, in a system including nanoparticles added thereto, surface unevenness tended not to be formed by the fine particles when a particular solvent was used, while the unevenness tended to be formed when another particular solvent was used. When the nanoparticles were not contained, the uneven surface shape did not differ significantly according to the type of the solvent. With consideration given to these phenomena, it can be presumed that since repulsive force is imposed on nanoparticles and fine particles when the nanoparticles are contained, the fine particles tend to be dispersed relatively uniformly and the movement of the fine particles can be controlled easily during the applying and drying steps, and therefore, the number of parts of the fine particles to be added can be reduced and the uneven surface shape of the present invention can be produced effectively. However, the present invention is not limited by this presumption.

In the component (B), the inorganic oxide particles are bound (surface-modified) with an organic compound having a polymerizable unsaturated group. The polymerizable unsaturated group is reacted with the component (A) to be cured, which results in an increase in hardness of the hard-coating layer. Preferable examples of the polymerizable unsaturated group include an acryloyl group, a methacryloyl group, a vinyl group, a propenyl group, a butadienyl group, a styryl group, an ethynyl group, a cinnamoyl group, a maleate group, and an acrylamide group. The organic compound having the polymerizable unsaturated group preferably is a compound having a silanol group inside a molecule or a compound that produces a silanol group through hydrolysis. It also is preferable that the organic compound having the polymerizable unsaturated group is one having a photosensitive group.

The amount of the component (B) to be added is preferably in the range of 100 to 200 parts by weight per 100 parts by weight of the component (A). When the amount of the component (B) to be added is 100 parts by weight or more, the hard-coated antiglare film can be prevented more effectively from curling and bending. When the amount is 200 parts by weight or less, high scratch resistance and pencil hardness can be obtained. The amount of the component (B) to be added is more preferably in the range of 100 to 150 parts by weight per 100 parts by weight of the component (A).

Adjustment in the amount of the component (B) to be added allows, for example, the refractive index of the hard-coating antiglare layer to be controlled. In order to lower the reflectance, it is advantageous that the hard-coating antiglare layer is allowed to have a lower refractive index. In the case where an antireflection layer (low refractive index layer) with a low refractive index is provided, it is possible to uniformly reduce the reflection of light in a visible light wavelength range by increasing the refractive index of the hard-coating antiglare layer.

The fine particles for forming the hard-coating antiglare layer have main functions of providing it with antiglare properties by forming the surface of the hard-coating antiglare layer to be formed into an uneven shape and controlling the haze value of the hard-coating antiglare layer. Controlling the difference in refractive index between the fine particles and the material for forming a hard-coating layer allows the haze value of the hard-coating antiglare layer to be designed. Examples of the fine particles include inorganic fine particles and organic fine particles. The inorganic fine particles are not particularly limited. Examples thereof include silicon oxide fine particles, titanium oxide fine particles, aluminum oxide fine particles, zinc oxide fine particles, tin oxide fine particles, calcium carbonate fine particles, barium sulfate fine particles, talc fine particles, kaolin fine particles, and calcium sulfate fine particles. The organic fine particles are not particularly limited. Examples thereof include polymethyl methacrylate resin powder (PMMA fine particles), silicone resin powder, polystyrene resin powder, polycarbonate resin powder, acrylic-styrene resin powder, benzoguanamine resin powder, melamine resin powder, polyolefin resin powder, polyester resin powder, polyamide resin powder, polyimide resin powder, and polyethylene fluoride resin powder. These inorganic fine particles and organic fine particles may be used alone or in a combination of two or more of them.

The weight average particle size of the fine particles preferably is in the range of 0.5 to 8 μm. When the weight average particle size of the fine particles exceeds the aforementioned range, the image sharpness is reduced. On the other hand, when it is shorter than the aforementioned range, sufficient antiglare properties cannot be obtained and thereby a problem of increased glare tends to arise. The weight average particle size of the fine particles is more preferably in the range of 2 to 6 μm, yet more preferably in the range of 3 to 6 μm. Furthermore, it also is preferable that the weight average particle size of the fine particles be in the range of 30% to 80% of the thickness of the hard-coating antiglare layer. The weight average particle size of the fine particles can be, for example, measured by the Coulter counting method. For instance, a particle size distribution measurement apparatus (COULTER MULTISIZER (product name), manufactured by Beckman Coulter, Inc.) using a pore electrical resistance method is used to measure an electrical resistance of an electrolyte corresponding to the volume of the fine particles when the fine particles pass through the pores. Thus, the number and volume of fine particles are measured and then the weight average particle size is calculated.

The shape of the fine particles is not particularly limited. For instance, they can have a bead-like, substantially spherical shape or can have an indeterminate shape like powder. However, the fine particles preferably have a substantially spherical shape, more preferably a substantially spherical shape with an aspect ratio of 1.5 or lower, and most preferably a spherical shape.

The ratio of the fine particles to be added is preferably in the range of 5 to 20 parts by weight and more preferably in the range of 5 to 17 parts by weight, per 100 parts by weight of the material for forming a hard-coating layer.

The thickness of the hard-coating antiglare layer is preferably in the range that is 1.2 to 3 times and more preferably 1.2 to 2 times the weight average particle size of the fine particles. Furthermore, from the viewpoints of applying properties and pencil hardness, the thickness of the hard-coating antiglare layer preferably is in the range of 8 to 12 μm, and it is preferable that the weight average particle size of the fine particles be adjusted so that the thickness is in this thickness range. The thickness in the predetermined range makes it easy to obtain the surface shape of the hard-coated antiglare film of the present invention, in which a large number of fine concavities and convexities are present independently, and sufficiently high hardness (for instance, a pencil hardness of at least 4H) of the hard-coating antiglare layer. Furthermore, the thickness exceeding the above-mentioned range causes problems in that the hard-coated antiglare film curls considerably to have deteriorated line traveling performance during the applying and further in that antiglare properties are deteriorated. On the other hand, when the thickness is less than the predetermined range described above, there is a problem in that glare cannot be prevented from occurring and thereby the sharpness deteriorates.

Preferably, the hard-coated antiglare film of the present invention has a haze value in the range of 4% to 30%. The aforementioned haze value is a haze value (cloudiness) of the entire hard-coated antiglare film, according to JIS K 7136 (2000 version). The haze value is more preferably in the range of 6% to 30%, yet more preferably in the range of 8% to 30%. In order to obtain a haze value in the aforementioned range, it is preferable that the fine particles and the material for forming a hard-coating layer be selected so that the difference in refractive index between the fine particles and the material for forming a hard-coating layer is in the range of 0.01 to 0.06. A haze value in the aforementioned range allows a clear image to be obtained and can improve the contrast in a dark place. When the haze value is excessively low, a failure due to glare tends to occur.

In the hard-coated antiglare film of the present invention, a surface of the antireflection layer has an uneven shape and an average angle of inclination θa satisfying 0.5≦θa≦1.5. In the present invention, the average angle of inclination θa is defined by the following mathematical formula (1). The average angle of inclination θa is measured by a method described in the examples described below, for example.

Average angle of inclination θa=tan⁻¹ Δa (1)

In the mathematical formula (1), Δa is, as shown in the following mathematical formula (2), a value obtained by dividing a sum (h1+h2+h3 . . . +hn) of differences (height h) between each of peaks in the respective mount shape and each of lowest points in the respective valley shapes, which are next to each other in a standard length L in a roughness curve, which is defined in JIS B 0601 (1994 version) by the standard length L. The roughness curve is a curve obtained by removing a component of a surface undulation that is longer than a predetermined wavelength from a cross-sectional curve using a phase compensation high-pass filter. Further, the cross-sectional curve is an outline appeared in a cut area when an objective surface is cut in a plane that is orthogonal to the objective surface. FIG. 9 shows an example of the roughness curve, the height h, and the standard line L.

Δa=(h1+h2+h3 . . . +hn)/L (2)

The θa is preferably in the range of 0.6 to 1.4, more preferably in the range of 0.65 to 1.35. When the θa is less than 0.5, antiglare properties are inferior. On the other hand, when it exceeds 1.5, intensive glare tends to occur.

The surface of the antireflection layer in the hard-coated antiglare film of the present invention has an uneven shape and an arithmetic average surface roughness Ra in the range of 0.05 to 0.15 μm, which is defined in JIS B 0601 (1994 version). Further, the hard-coated antiglare film of the present invention includes at least 80 convexities that exceed a roughness mean line of a surface roughness profile in a 4-mm long portion at an arbitrary location of the surface of the antireflection layer, convexities that exceed a standard line that is in parallel with the roughness mean line and is located at a height of 0.1 μm, and no convexities in which line segments of portions of the standard line that cross the convexities each have a length of 50 μm or longer. The Ra is preferably in the range of 0.07 to 0.12 μm, more preferably in the range of 0.08 to 0.10 μm. In order to prevent reflections of an image and external light at the surface of the hard-coated antiglare film, a certain degree of surface roughness is required, and an Ra of 0.05 μm or more allows the reflections to be reduced. Furthermore, in order to maintain antiglare properties, an Ra of 0.15 μm or less is required, and further, it is advantageous not to have roughness in the entire surface but to have an uneven shape of the surface such as one having undulation or fine concavities and convexities sparsely. When the hard-coated antiglare film including at least 80 convexities that exceed the roughness mean line and having the Ra of 0.15 μm or less, is used in an image display or the like, the reflected light can be prevented from scattering when viewed from an oblique direction, which results in a reduction in white blur and also in an improvement in contrast in a bright place. The number of convexities is more preferably in the range of 80 to 110, yet more preferably in the range of 90 to 100. When the number of convexities is less than 80, glare tends to occur. On the other hand, when it exceeds 110, tinting of the entire surface tends to become intensive.

The hard-coated antiglare film of the present invention includes convexities that exceed a standard line that is in parallel with a roughness mean line of the surface roughness profile and is located at a height of 0.1 μm. Although the standard line that is located at a height of 0.1 μm crosses the convexities, sizes of the convexities are those in which line segments of portions of the standard line that cross the convexities each have a length of shorter than 50 μm. Further, it is preferable that at least 50 of the convexities in which the line segments each have a length of 20 μm or shorter be formed in a 4-mm long portion at an arbitrary location of the surface of the antireflection layer. Formation of at least 50 convexities in which the line segments of portions each have a length of 20 μm or shorter is preferable in terms of antiglare properties and also tends not to cause glare to occur. On the other hand, the presence of convexities in which the line segments each have a length of 50 μm or longer tends to cause glare to occur. In the case of a hard-coated antiglare film including no convexities in which the line segments each have a length of 50 μm or longer, at least 80 convexities that exceed the roughness mean line are formed, and the Ra is 0.15 μm or less, the presence of a large number of relatively uniform fine concavities and convexities allows scattering to occur uniformly in an excellent manner and glare can be prevented from occurring even in a high definition panel. The number of the convexities in which the length is 20 μm or shorter is preferably in the range of 50 to 90 and more preferably in the range of 60 to 80. An excessively large number of convexities in which the line segments each have a length of 20 μm or shorter tends to cause intensive white blur.

As is defined by the Ra and the size and number of the convexities, the hard-coated antiglare film of the present invention includes: a large number of independent fine concavities and convexities; the predetermined number of independent fine concavities and convexities; and no convexities in which the line segments each have a length of 50 μm or longer, and preferably has inner scatter defined by the haze value in the aforementioned range, which allows both the improvement in antiglare properties and the elimination of glare to be obtained.

The hard-coating antiglare layer composing the hard-coated antiglare film of the present invention can be produced as follows. That is, for example, a material for forming a hard-coating antiglare layer is prepared that contains the fine particles, the material for forming a hard-coating layer, and a solvent, the material for forming a hard-coating antiglare layer is applied onto at least one surface of the transparent plastic film substrate to form a film (hereinafter referred to as an “applied film”), and the applied film is then cured to form the hard-coating antiglare layer. In the production of the hard-coating antiglare layer according to the present invention, it also is possible to use, for example, a transfer method using a mold and a method for providing an uneven shape by a suitable method such as sandblast or embossing roll, in combination.

The solvent is not particularly limited, various solvents can be used, and the solvents may be used alone or in a combination of two or more of them. The type of the solvent and the solvent ratio that are optimal to obtain the hard-coating antiglare layer in the present invention depending on the composition of a material for forming a hard-coating layer and the type of fine particles may be used.

For example, when 5 parts by weight of fine particles are added to each material for forming a hard-coating layer that was used in the examples described below, thereby the solid concentration is 45% by weight, and the thickness of the hard-coating antiglare layer is about 10 μm, a hard-coating antiglare layer that can realize the properties of the present invention, in which the ratio of MIBK/MEK is in the range of at least 1.5/1 to 2.0/1 (weight ratio), can be obtained. In the case of butyl acetate/MEK, a hard-coating antiglare layer that can realize the properties of the present invention in the range of at least 1.5/1 to 3.0/1 (weight ratio) can be obtained. As in the case of the materials for forming a hard-coating layer that were used in the examples described below, when the component (B) is nanoparticles, it is presumed that the dispersed state of the nanoparticles and the fine particles is changed according to, for instance, the type and mixing ratio of the solvent, which results in a change in tendency of concavities and convexities on the surface of the hard-coating antiglare layer. However, the present invention is not at all limited by this presumption. In the case of, for example, the materials for forming a hard-coating layer described below, concavities and convexities tend to be formed on the surface when the solvent is, for example, MEK, cyclopentanone, ethyl acetate, or acetone, while concavities and convexities tend not to be formed on the surface when the solvent is, for example, MIBK, toluene, butyl acetate, 2-propanol, or ethanol. Accordingly, in order to obtain a hard-coated antiglare film having the properties of the present invention, it also is preferable that the surface shape be controlled through selection of the type and ratio of the solvent.

Various types of leveling agents can be added to the material for forming a hard-coating antiglare layer. The leveling agent may be, for example, a fluorine or silicone leveling agent, preferably a silicone leveling agent. As the silicone leveling agent, the reactive silicone is particularly preferred. Addition of the reactive silicone can impart lubricity to the surface and maintain scratch resistance over a long period of time. In the case of using a reactive silicone having a hydroxyl group, as described below, when an antireflection layer (a low refractive index layer) containing a siloxane component is formed on the hard-coating antiglare layer, the adhesion between the antireflection layer and the hard-coating antiglare layer is improved.

The amount of the leveling agent to be added can be, for example, 5 parts by weight or less, preferably in the range of 0.01 to 5 parts by weight, per 100 parts by weight of entire resin components.

The material for forming a hard-coating antiglare layer may contain, for example, a pigment, a filler, a dispersing agent, a plasticizer, an ultraviolet absorbing agent, a surfactant, an antifoulant, an antioxidant, or a thixotropy-imparting agent, as long as the performance is not impaired, if necessary. These additives may be used alone or in a combination of two or more of them.

Known photopolymerization initiators, for example, those described in JP 2008-88309 A, can be used to the material for forming a hard-coating antiglare layer.

Examples of the method for applying the material for forming a hard-coating antiglare layer onto the transparent plastic film substrate include applying methods such as fountain coating, die coating, spin coating, spray coating, gravure coating, roll coating, and bar coating.

The material for forming a hard-coating antiglare layer is applied onto the transparent plastic film substrate to form a applied film, and then the applied film is cured. Preferably, the applied film is dried before being cured. The drying can be carried out by, for example, allowing it to stand, air drying by blowing air, drying by heating, or a combination thereof.

The method for curing the applied film formed of the material for forming a hard-coating antiglare layer is not particularly limited but is preferably ultraviolet curing. The amount of irradiation with the energy radiation source preferably is in the range of 50 to 500 mJ/cm² in terms of accumulative exposure at an ultraviolet wavelength of 365 nm. When the amount of irradiation is at least 50 mJ/cm², the applied film can be cured more sufficiently and the resultant hard-coating antiglare layer also has a further sufficiently high hardness. When the amount of irradiation is 500 mJ/cm² or lower, the resultant hard-coating antiglare layer can be prevented from being colored.

In the hard-coated antiglare film of the present invention, an antireflection layer (low refractive index layer) is disposed on the hard-coating antiglare layer. Light reflection at the interface between air and the hard-coating antiglare layer is one of the factors that cause a reduction in visibility of images when an image display is equipped with the hard-coated antiglare film. The antireflection layer reduces the surface reflection. The hard-coating antiglare layers and the antireflection layers may be formed on both surfaces of the transparent plastic film substrate, respectively. Furthermore, the hard-coating antiglare layer and the antireflection layer each may have a multilayer structure in which at least two layers are stacked together.

In the present invention, the antireflection layer is a thin optical film having a strictly controlled thickness and refractive index, or a laminate including at least two layers of the thin optical films that are stacked together. In the antireflection layer, the antireflection function is produced by allowing opposite phases of incident light and reflected light to cancel each other out by using the effect of interference of light. The wavelength range of visible light that allows the antireflection function to be produced is, for example, 380 to 780 nm, and the wavelength range in which the visibility is particularly high is in the range of 450 to 650 nm. Preferably, the antireflection layer is designed to have a minimum reflectance at the center wavelength 550 nm of the range.

When the antireflection layer is designed based on the effect of interference of light, the interference effect can be enhanced by, for example, a method for increasing the difference in refractive index between the antireflection layer and the hard-coating antiglare layer. Generally, in an antireflection multilayer having a structure including two to five thin optical layers (each with strictly controlled thickness and refractive index) that are stacked together, components with different refractive indices from each other are used to form a plurality of layers with a predetermined thickness. Thus, the antireflection layer can be optically designed at a higher degree of freedom, the antireflection effect can be enhanced, and the spectral reflection characteristics also can be made even (flat) in the visible light range. Since each layer of the thin optical film must be precise in thickness, a dry process such as vacuum deposition, sputtering, or CVD is generally used to form each layer.

The more optical thin layers to be stacked, the lower the reflectance. However, the use of the multiple optical thin layers involves the cost thereof. For example, it is preferable that about five optical thin layers are used when the reflectance is desired to be about 0.3%. When a first SiO₂ layer, a first TiO₂ layer, a second SiO₂ layer, a second TiO₂ layer, and a third SiO₂ layer are formed on the hard-coating antiglare layer in this order, the thickness of the first SiO₂ layer is preferably in the range of 10 to 40 nm, more preferably in the range of 10 to 30 nm, the thickness of the first TiO₂ layer is preferably in the range of 10 to 40 nm, more preferably in the range of 10 to 30 nm, and the thickness of the second SiO₂ layer is preferably in the range of 10 to 40 nm, more preferably in the range of 15 to 35 nm. The thickness of the second TiO₂ layer is preferably in the range of 70 to 140 nm, more preferably in the range of 110 to 130 nm, and the thickness of the third SiO₂ layer is preferably in the range of 70 to 90 nm, more preferably in the range of 75 to 85 nm. The total thickness of the antireflection layer is preferably in the range of 170 to 350 nm, more preferably in the range of 220 to 310 nm. The antireflection layer is thinner than the hard-coating antiglare layer, and has a thickness with an extent that the layer itself is less susceptible to an uneven shape on the surface thereof. Therefore, it can be said that the specific surface shape in the hard-coated antiglare film of the present invention is formed mainly by the hard-coating antiglare layer.

One characteristic of the hard-coated antiglare film of the present invention is having a low reflectance. The hard-coated antiglare film of the present invention further has the following characteristics, for example. Light is applied to the surface of the hard-coated antiglare film at an angle of 10° with a direction perpendicular to the film so that a light intensity of the topmost surface of the film becomes 1000 Lx. In the case of assuming that a reflection intensity of the hard-coated film with a refractive index of 1.53 is 1, a reflection intensity ratio of the surface of the hard-coated antiglare film of the present invention becomes 3 or less. The hard-coated antiglare film having a configuration of the present invention and having a reflection intensity ratio of 3 or less can prevent “tinting” from occurring. In this case, a reflected hue x can satisfy 0.2≦x≦0.4, a reflected hue y can satisfy 0.2≦y≦0.4, and the hard-coated antiglare film on which “tinting” is not observed can be obtained. Also in the case where antiglare properties are too high, there is a case that “tinting” is observed. Therefore, also from the viewpoint of it, the θa is defined to be 1.5 or less, and the Ra is defined to be 0.15 μm or less.

Further, in the hard-coated antiglare film of the present invention, it is also preferable that, in order to prevent adhesion of contaminant and improve properties to easily remove adherent contaminant, a contamination preventive layer formed of a silane compound having a fluorine group, an organic compound having the same, or the like is stacked on the antireflection layer.

With respect to the hard-coated antiglare film of the present invention, it is preferable that at least one of the transparent plastic film substrate and the hard-coating antiglare layer be subjected to a surface treatment. When the transparent plastic film substrate is subjected to the surface treatment, adhesion thereof to the hard-coating antiglare layer, the polarizer, or the polarizing plate further improves. When the hard-coating antiglare layer is subjected to the surface treatment, adhesion thereof to the antireflection layer, the polarizer, or the polarizing plate further improves.

As described above, the hard-coated antiglare film of the present invention can be produced by forming the hard-coating antiglare layer on at least one surface of the transparent plastic film substrate, and further forming the antireflection layer on the surface of the formed hard-coating antiglare layer. The hard-coated antiglare film of the present invention can be produced by producing methods other than that described above. The hard-coated antiglare film of the present invention can have, for example, a hardness of at least 2H in terms of pencil hardness, although it is affected by the thickness of the layer.

One example of the hard-coated antiglare film of the present invention can be one in which a hard-coating antiglare layer and an antireflection layer are formed on one surface of a transparent plastic film substrate. The hard-coating antiglare layer contains fine particles, whereby the surface of the hard-coating antiglare layer has an uneven shape. In this example, a hard-coating antiglare layer is formed on the surface of a transparent plastic film substrate. However, the present invention is not limited to this, and the hard-coated antiglare film may be a hard-coated antiglare film in which hard-coating antiglare layers are formed on both surfaces of the transparent plastic film substrate. Further, the hard-coating antiglare layer of this example is a single layer. However, the present invention is not limited to this, and the hard-coating antiglare layer may have a multilayer structure in which at least two layers are stacked together.

In a hard-coated antiglare film including the transparent plastic film substrate, the hard-coating antiglare layer and the like formed on one surface of the transparent plastic film substrate, in order to prevent curling, the other surface may be subjected to solvent treatment. Further, in the hard-coated antiglare film including the transparent plastic film substrate, the hard-coating antiglare layer and the like formed on one surface of the transparent plastic film substrate, and the like, in order to prevent curling, a transparent resin layer may be formed on the other surface.

The transparent plastic film substrate side of the hard-coated antiglare film of the present invention is generally bonded to an optical component for use in a LCD with a pressure-sensitive adhesive or an adhesive. Before bonding, the transparent plastic film substrate surface may be subjected to various types of surface treatment as described above.

The optical component can be, for example, a polarizer or a polarizing plate. Generally, a polarizing plate has a structure including a polarizer and a transparent protective film formed on one or both surfaces of the polarizer. If the transparent protective films are formed on both surfaces of the polarizer, respectively, the front and rear transparent protective films may be formed of the same material or different materials. Polarizing plates are generally disposed on both sides of a liquid crystal cell. Furthermore, polarizing plates are disposed such that the absorption axes of two polarizing plates are substantially perpendicular to each other.

Next, an optical component including a hard-coated antiglare film of the present invention stacked therein is described using a polarizing plate as an example. The hard-coated antiglare film of the present invention and a polarizer or polarizing plate can be stacked together with an adhesive or a pressure-sensitive adhesive and thereby a polarizing plate having the function according to the present invention can be obtained.

The polarizer is not particularly limited and various types can be used. Examples of the polarizer include: a film that is uniaxially stretched after a hydrophilic polymer film, such as a polyvinyl alcohol type film, a partially formalized polyvinyl alcohol type film, or an ethylene-vinyl acetate copolymer type partially saponified film, is allowed to adsorb dichromatic substances such as iodine or a dichromatic dye; and a polyene type oriented film, such as a dehydrated polyvinyl alcohol film or a dehydrochlorinated polyvinyl chloride film.

Preferably, the transparent protective film formed on one or both surfaces of the polarizer is superior in, for example, transparency, mechanical strength, thermal stability, moisture-blocking properties, and retardation value stability. Examples of the material for forming the transparent protective film include the same materials as those used for the aforementioned transparent plastic film substrate.

The polymer films described in JP 2001-343529 A (WO01/37007) also can be used as the transparent protective film. The polymer film can be produced by extruding the resin composition in the form of a film. The polymer film has a small retardation and a small photoelastic coefficient and thus can eliminate defects such as unevenness due to distortion when it is used for a protective film of, for example, a polarizing plate. The polymer film also has low moisture permeability and thus has high durability against moisture.

From the viewpoints of, for example, polarizing properties and durability, the transparent protective film is preferably a film made of a cellulose resin such as triacetyl cellulose or a film made of a norbornene resin. Examples of commercially available products of the transparent protective film include FUJITAC (product name) (manufactured by Fujifilm Corporation), ZEONOA (product name) (manufactured by Nippon Zeon Co., Ltd.), and ARTON (product name) (manufactured by JSR Corporation). The thickness of the transparent protective film is not particularly limited. It can be, for example, in the range of 1 to 500 μm from the viewpoints of strength, workability such as handling properties, and thin layer properties.

The structure of a polarizing plate with the hard-coated antiglare film stacked therein is not particularly limited. The polarizing plate may have, for example, a structure in which the transparent protective film, the polarizer, and the transparent protective film are stacked in this order on the hard-coated antiglare film, or a structure in which the polarizer and the transparent protective film are stacked in this order on the hard-coated antiglare film.

The image display of the present invention can have the same configuration as those of conventional image displays except for including a hard-coated antiglare film of the present invention. For example, LCD, can be produced by suitably assembling the respective components such as a liquid crystal cell, optical components such as a polarizing plate, and, if necessity, a lighting system (for example, a backlight), and incorporating a driving circuit.

The liquid crystal display of the present invention is used for any suitable applications. Examples of the applications include office equipment such as a PC monitor, a notebook PC, and a copy machine, portable devices such as a mobile phone, a watch, a digital camera, a personal digital assistant (PDA), and a handheld game machine, home electric appliances such as a video camera, a television set, and a microwave oven, vehicle equipment such as a back monitor, a monitor for a car-navigation system, and a car audio device, display equipment such as an information monitor for stores, security equipment such as a surveillance monitor, and nursing and medical equipment such as a monitor for nursing care and a monitor for medical use.

### EXAMPLES

Next, the examples of the present invention are described together with the comparative examples. The present invention is not limited by the following examples or comparative examples. Various properties in the examples and comparative examples described below were evaluated or measured by the following methods.

(Haze Value)

A haze meter (“HM-150” (product name), manufactured by Murakami Color Research Laboratory) was used to measure a haze value according to JIS K 7136 (2000 version) (haze (cloudiness)).

(Average Angle of Inclination θa and Arithmetic Average Surface Roughness Ra)

A glass sheet (with a thickness of 1.3 mm) manufactured by Matsunami Glass Ind., Ltd. was bonded to the surface of a hard-coated antiglare film on which no hard-coating antiglare layer had been formed, with a pressure-sensitive adhesive. Subsequently, the surface shape of the hard-coating antiglare layer was measured on the condition that a cutoff value is 0.8 mm using a high-precision microfigure measuring instrument (SURFCORDER ET4000 (product name), manufactured by Kosaka Laboratory Ltd.), and the average angle of inclination θa and the arithmetic average surface roughness Ra were then determined. The high-precision microfigure measuring instrument automatically calculated the average angle of inclination θa and the arithmetic average surface roughness Ra. The average angle of inclination θa and the arithmetic average surface roughness Ra were indicated according to JIS B 0601 (1994 version).

(The Number of Convexities that Exceed Roughness Mean Line of Surface Roughness Profile)

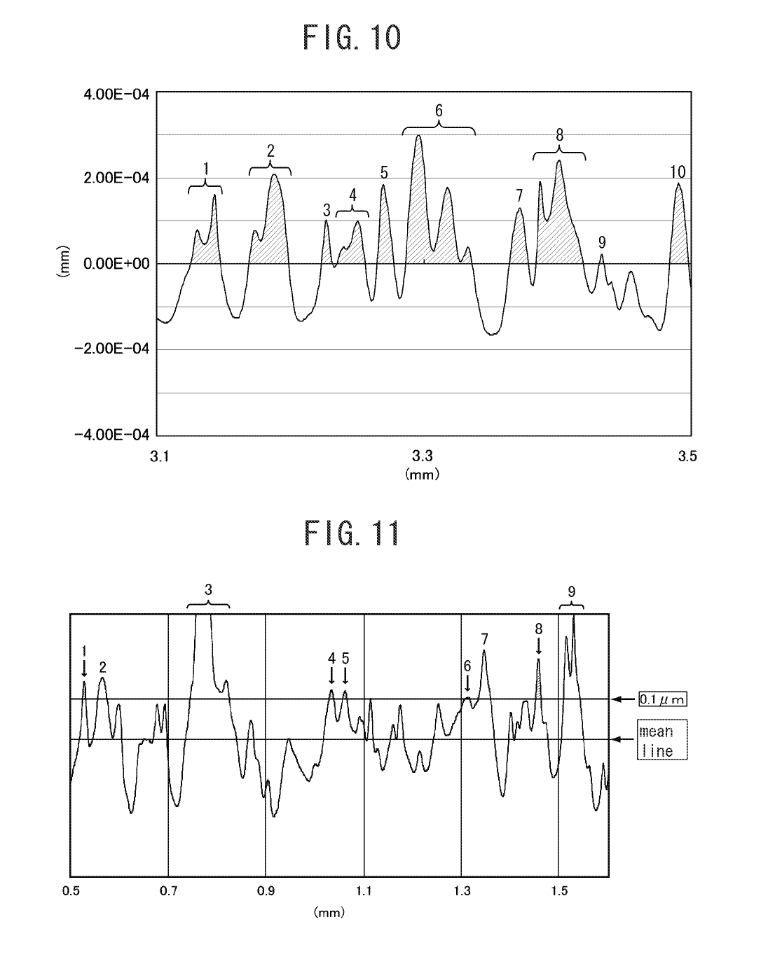

In the roughness profile (the F profile) obtained through the measurement of the surface shape, the number of convexities that exceed the roughness mean line of the profile on an arbitrary 4-mm straight line was measured and was then used as a measured value. FIG. 10 shows a schematic drawing for explaining the method for measuring the number of the convexities. The convexities to be measured were hatched. The number of convexities to be measured was not the number of peaks but the number of portions that cross the mean line. For instance, when the profile includes a plurality of peaks in the range exceeding the mean line, such as those indicated with 1, 2, 4, 6, and 8, the number of convexities to be measured is one. In FIG. 10, the total number of the convexities is 10.

(The Number of Convexities that Exceed Standard Line)

In the roughness profile (the F profile) obtained through the measurement of the surface shape, the line that was in parallel with the roughness mean line of the profile and was located at a height of 0.1 μm was taken as a standard line. With respect to the convexities that exceed the standard line on a 4-mm straight line in an arbitrary measurement region, the number of convexities in which line segments of portions of the standard line that cross the convexities each have a length of 50 μm or longer as well as the number of convexities in which line segments of portions the standard line that cross the convexities each have a length of 20 μm or shorter were measured and were then used as measured values. FIG. 11 shows a schematic drawing for explaining the method for measuring the number of the convexities. The convexities to be measured were hatched. The number of convexities to be measured was not the number of peaks but the number of portions that cross the standard line. For instance, when the profile includes a plurality of peaks in the range exceeding the standard line, such as those indicated with 3 and 9, the number of convexities to be measured is 1. In FIG. 11, the number of convexities of 50 μm or longer is one, specifically the peak 3 in the profile, while the number of convexities of 20 μm or shorter is 5 in total, specifically peaks 1, 4, 5, 6, and 8 in the profile.

(Reflection Intensity Ratio)

(1) A black acrylic plate (with a thickness of 2.0 mm and a size of 50 mm×50 mm, manufactured by Mitsubishi Rayon Co., Ltd.) was bonded to the surface of a hard-coated antiglare film on which no hard-coating antiglare layer had been formed, with an acrylic pressure-sensitive adhesive with a film thickness of about 20 μm. Thus, a sample having a back surface with no reflection was produced.
(2) An optical receiver (SPECTRORADIOMETER CS1000A, manufactured by Konica Minolta Holdings, Inc.) was placed at a distance of 50 cm above the sample so as to be parallel to the sample. A ring illumination (MHF-G150LR, with a diameter of 37 mm, manufactured by MORITEX Corporation) was placed at a distance of 105 mm from the sample. An irradiation angle at which light from the ring illumination that is at this set position is applied to a panel was 10° with the panel.
(3) A light intensity was adjusted so as to be 1000 Lx using an illuminometer (ILLUMINANCE METER, manufactured by TOPCOM Corporation).
(4) A Y value and a chromaticity coordinate in a CIE 1931 color system (a 2-degree field of view XYZ color system) in the middle of a blackboard with a hard-coated antiglare film were determined, and the Y value was set to a reflection intensity.
(5) A hard-coated film was produced in the same manner as in the following Comparative Example 5 except that an antireflection layer was not provided. As a standard value, a reflection intensity was measured by the aforementioned methods (1) to (4) using the hard-coated film, was regarded as a standard value of 100 (actual value: 59). With respect to a surface roughness of the standard hard-coated film, an Ra was 0.002 μm, and a θa was 0.05°.
(6) A ratio of reflection intensity of a sample assuming that a reflection intensity of the standard hard-coated film is 1 was calculated and was used as a reflection intensity ratio.

(Reflected Hue Evaluation)

For a reflected hue evaluation, the chromaticity coordinate (x, y) obtained in the aforementioned method (4) was used in the measurement of the reflection intensity ratio.

(Evaluation of Antiglare Properties)

(1) A black acrylic plate (with a thickness of 2.0 mm, manufactured by Mitsubishi Rayon Co., Ltd.) was bonded to the surface of a hard-coated antiglare film on which no hard-coating antiglare layer had been formed, with a pressure-sensitive adhesive. Thus, a sample having a back surface with no reflection was produced.
(2) In an office environment (about 1000 Lx) where displays are used in general, the antiglare properties of the sample produced above were judged by visual observation according to the following criteria:

AA: face reflection was not observed and had no effect on visibility,

A: face reflection was observed with no problem in practical use,

B: face reflection was observed and slightly hindered the visual observation, and

C: face reflection was clearly observed, and significantly hindered the visual observation.

(Evaluation of Glare)

The surface of a hard-coated antiglare film on which no hard-coating antiglare layer had been formed was bonded to a 1.1-mm thick glass sheet with a pressure-sensitive adhesive. Thus, a measurement sample was obtained. This sample was set on a mask pattern placed above a backlight (“LIGHT-VIEWER 5700” (product name), manufactured by Hakuba Photo Industry Co., Ltd.). The mask pattern used herein was a lattice-like pattern (150 ppi) having an opening with a size of 146 μm×47 μm, a vertical line with a width of 19 μm, and a horizontal line with a width of 23 μm. The distance from the mask pattern to the hard-coating antiglare layer was 1.1 mm, while the distance from the backlight to the mask pattern was 1.5 mm. Then glare of the hard-coated antiglare film was judged by visual observation according to the following criteria:

AA: almost no glare was observed,

A: little glare was observed, but did not hinder the visual observation, and

B: intensive glare was observed.

(Refractive Indices of Transparent Plastic Film Substrate and Hard-Coating Layer)

The refractive indices of a transparent plastic film substrate and a hard-coating layer were measured using an Abbe refractometer (DR-M2/1550 (product name)) manufactured by Atago Co., Ltd. by a measuring method specified for the apparatus. The measurement was carried out, with monobromonaphthalene being selected as an intermediate liquid, and with measuring light being allowed to be incident on the measuring planes of the film substrate and the hard-coating layer.

(Refractive Index of Fine Particles)

Fine particles were placed on a slide glass, and a refractive index standard solution was dropped onto the fine particles. Thereafter, a cover glass was placed thereon. Thus, a sample was prepared. The sample was observed with a microscope and thereby the refractive index of the refractive index standard solution that was obtained at the point where the profiles of the fine particles were most difficult to view at the interface with the refractive index standard solution was used as the refractive index of the fine particles.

(Weight Average Particle Size of Fine Particles)

By the Coulter counting method, the weight average particle size of the fine particles was measured. Specifically, a particle size distribution measurement apparatus (COULTER MULTISIZER (product name), manufactured by Beckman Coulter, Inc.) using a pore electrical resistance method was employed to measure electrical resistance of an electrolyte corresponding to the volume of the fine particles when the fine particles passed through the pores. Thus, the number and volume of the fine particles were measured and then the weight average particle size thereof was calculated.

(Thickness of Hard-Coating Antiglare Layer)

A thickness gauge of a microgauge type, manufactured by Mitutoyo Corporation was used to measure the total thickness of the hard-coated antiglare film. The thickness of the transparent plastic film substrate was subtracted from the total thickness. Thus, the thickness of the hard-coating antiglare layer was calculated.

### Example 1

Provided was a material for forming a hard-coating layer (“OPSTAR Z7540” (product name), manufactured by JSR Corporation, solid content; 56% by weight, solvent; butyl acetate/methyl ethyl ketone (MEK)=76/24 (weight ratio)) containing a component (A), in which silica nanoparticles (a component (B)) obtained by binding between inorganic oxide particles and an organic compound having a polymerizable unsaturated group is dispersed. The material for forming a hard-coating layer contains; the component (A); dipentaerythritol and isophorone diisocyanate polyurethane; and the component (B); silica fine particles (with a weight average particle size of 100 nm or shorter) whose surfaces are modified by an organic molecule, which satisfy component (A) in total:component (B)=2:3 (weight ratio). The cured film of the material for forming a hard-coating layer had a refractive index of 1.485. 6 parts by weight of cross-linked acryl-styrene particles (“TECHPOLYMER SSX1055QXE” (product name), with a weight average particle size of 5.5 μm and a reflective index of 1.515, manufactured by SEKISUI PLASTICS CO., Ltd.) used as the fine particles, 0.1 parts by weight of leveling agent (“GRANDIC PC-4100” (product name), manufactured by DIC Corporation), and 0.5 parts by weight of photopolymerization initiator (“IRGACURE 127” (product name), manufactured by Ciba Specialty Chemicals) were mixed per 100 parts by weight of resin solid content of the material for forming a hard-coating layer. This mixture was diluted so as to have a solid concentration of 45% by weight, and a ratio of butyl acetate to MEK of 2/1 (weight ratio). Thus, a material for forming a hard-coating antiglare layer was prepared.

A triacetyl cellulose film (“TD80UL” (product name), with a thickness of 80 μm and a refractive index of 1.48, manufactured by Fujifilm Corporation) was provided as a transparent plastic film substrate. The material for forming a hard-coating antiglare layer was applied onto one surface of the transparent plastic film substrate using a comma coater. Thus, an applied film was formed. Subsequently, it was heated at 100° C. for one minute and thus the applied film was dried. Thereafter, it was irradiated with ultraviolet light at an accumulated light intensity of 300 mJ/cm² using a high pressure mercury lamp and thereby the applied film was cured to form a 9-μm thick hard-coating antiglare layer.

An antireflection layer having a SiO₂ layer (with a thickness of 20 nm), a TiO₂ layer (with a thickness of 20 nm), a SiO₂ layer (with a thickness of 25 nm), a TiO₂ layer (with a thickness of 120 nm), and a SiO₂ layer (with a thickness of 80 nm) laminated in this order so as to have a five-layered structure was formed on the formed hard-coating antiglare layer by sputtering. Thus, a hard-coated antiglare film of Example 1 was obtained.

### Example 2

A hard-coated antiglare film of Example 2 was obtained by the same method as in Example 1 except that silicon fine particles (“TOSPEARL 145” (product name), with a weight average particle size of 4.5 μm and a refractive index of 1.425, manufactured by Momentive Performance Materials Inc.) were used as the fine particles, and 5 parts by weight of the silicon fine particles were mixed per 100 parts by weight of resin solid content of the material for forming a hard-coating layer.

### Example 3

A hard-coated antiglare film of Example 3 was obtained by the same method as in Example 1 except that 10 parts by weight of the same cross-linked acryl-styrene particles as in Example 1 were mixed per 100 parts by weight of resin solid content of the same material for forming a hard-coating layer as in Example 1.

### Comparative Example 1

A hard-coated antiglare film of Comparative Example 1 was obtained by the same method as in Example 1 except that a 5 μm-thick hard-coating antiglare layer was formed by applying a material for forming a hard-coating antiglare layer composed of an ultraviolet curable resin and fine particles onto one surface of the transparent plastic film substrate.

### Comparative Example 2

As a material for forming a hard-coating layer, provided was an ultraviolet curable resin (“UNIDIC 17-806” (product name), manufactured by DIC Corporation, solid content: 80% by weight, solvent: butyl acetate) composed of isocyanurate triacrylate, pentaerythritol triacrylate, dipentaerythritol hexaacrylate, and isophorone diisocyanate polyurethane. The cured film of the material for forming a hard-coating layer had a refractive index of 1.53. 0.5 parts by weight of leveling agent (“MEGAFAC F-470N” (product name), manufactured by DIC Corporation), 4.3 parts by weight of amorphous silica particles with a weight average particle size of 4.2 μm (“SYLYSIA 436” (product name), with a refractive index of 1.46, manufactured by Fuji Silysia Chemical Ltd.), and 5 parts by weight of photopolymerization initiator (“IRGACURE 184” (product name), manufactured by Ciba Specialty Chemicals) per 100 parts by weight of resin solid content of the material for forming a hard-coating layer were dissolved or dispersed in toluene so as to have a solid concentration of 44% by weight. Thus, a material for forming a hard-coating antiglare layer was prepared.

The material for forming a hard-coating antiglare layer was applied onto one surface of a transparent plastic film substrate using a barcoater. Thus, an applied film was formed. Substantially, it was heated at 100° C. for 1 minute, and thus the applied film was dried. Thereafter, it was irradiated with ultraviolet light at an accumulated light intensity of 300 mJ/cm² using a metal halide lamp, thereby the applied film was cured to form a 5 μm-thick hard-coating antiglare layer. Then, the same antireflection layer as in Example 1 was formed on the formed hard-coating antiglare layer. Thus, a hard-coated antiglare film of Comparative Example 2 was obtained.

### Comparative Example 3

The same material for forming a hard-coating layer as in Comparative Example 2 was prepared. 0.5 parts by weight of leveling agent (“MEGAFAC F-470N” (product name), manufactured by DIC Corporation), 8 parts by weight of amorphous silica particles with a weight average particle size of 2.5 μm (“SYLOPHOBIC 702” (product name) with a refractive index of 1.46, manufactured by Fuji Silysia Chemical Ltd.), 7 parts by weight of amorphous silica particles with a weight average particle size of 1.5 μm (“SYLOPHOBIC 100” (product name) with a refractive index of 1.46, manufactured by Fuji Silysia Chemical Ltd.), and 5 parts by weight of photopolymerization initiator (“IRGACURE 184” (product name), manufactured by Ciba Specialty Chemicals) per 100 parts by weight of resin solid content of the material for forming a hard-coating layer were dissolved or dispersed in a mixed solvent (toluene:butyl acetate=85:15 (weight ratio)) so as to have a solid concentration of 38% by weight. Thus, a material for forming a hard-coating antiglare layer was prepared.

The material for forming a hard-coating antiglare layer was applied onto one surface of a transparent plastic film substrate using an comma coater. Thus, an applied film was formed. Subsequently, it was heated at 100° C. for one minute and thus the applied film was dried. Thereafter, it was irradiated with ultraviolet light at an accumulated light intensity of 300 mJ/cm² using a metal halide lamp and thereby the applied film was cured to form a 4-μm thick hard-coating antiglare layer. The same antireflection layer as in Example 1 was formed on the formed hard-coating antiglare layer. Thus, a hard-coated antiglare film of Comparative Example 3 was obtained.

### Comparative Example 4

100 parts by weight of urethane acrylate ultraviolet curable resin, 11.6 parts by weight of amorphous silica particles with a weight average particle size of 1.5 μm (“SYLOPHOBIC 100” (product name), with a refractive index of 1.46, manufactured by Fuji Silysia Chemical Ltd.), 0.5 parts by weight of leveling agent (“MEGAFAC F470N” (product name), manufactured by DIC Corporation), 2.5 parts by weight of synthesized smectite, and 5 parts by weight of photopolymerization initiator (“IRGACURE 907” (product name), manufactured by Ciba Specialty Chemicals) were diluted with a mixed solvent (butyl acetate: toluene=13:87 (weight ratio)) so as to have a solid concentration of 42% by weight. Thus, a material for forming a hard-coating layer was prepared.

The material for forming a hard-coating layer was applied onto one surface of a transparent plastic film substrate using a bar coater. Thus, an applied film was formed. Subsequently, it was heated at 100° C. for one minute and thus the applied film was dried. Thereafter, it was irradiated with ultraviolet light at an accumulated light intensity of 300 mJ/cm² using a metal halide lamp and thereby the applied film was cured to form a 5-μm thick hard-coating antiglare layer. The same antireflection layer as in Example 1 was formed on the formed hard-coating antiglare layer. Thus, a hard-coated antiglare film of Comparative Example 4 was obtained.

### Comparative Example 5

A low reflection hard-coated film of Comparative Example 5 was obtained by the same method as in Comparative Example 2 except that amorphous silica particles were not added.

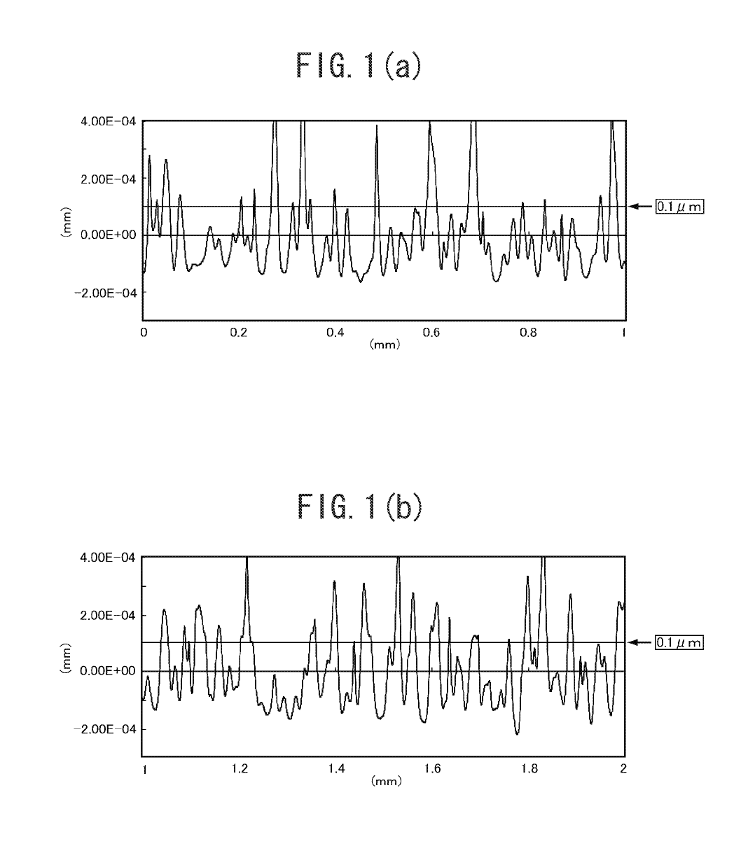

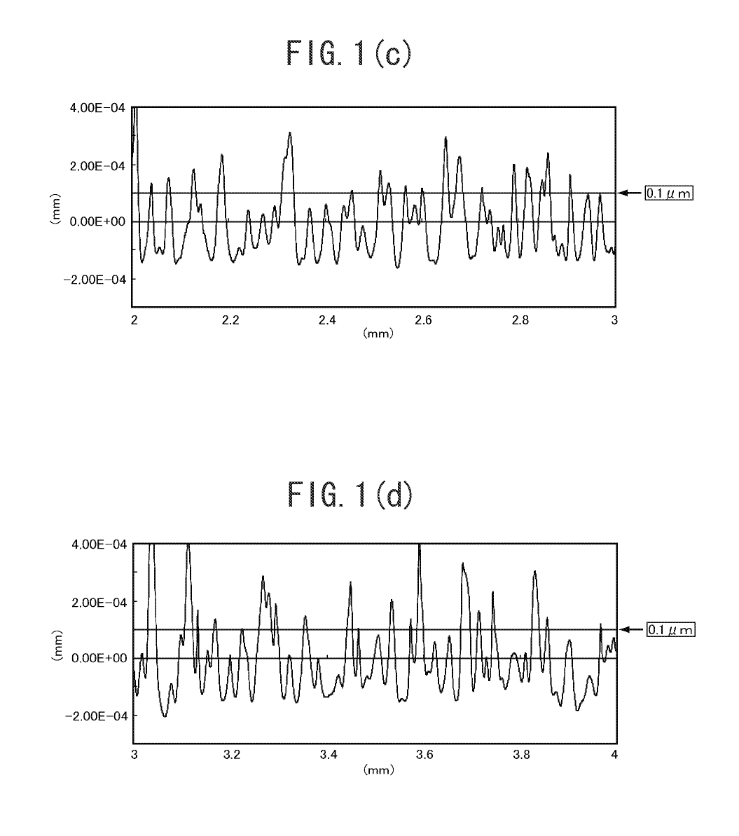

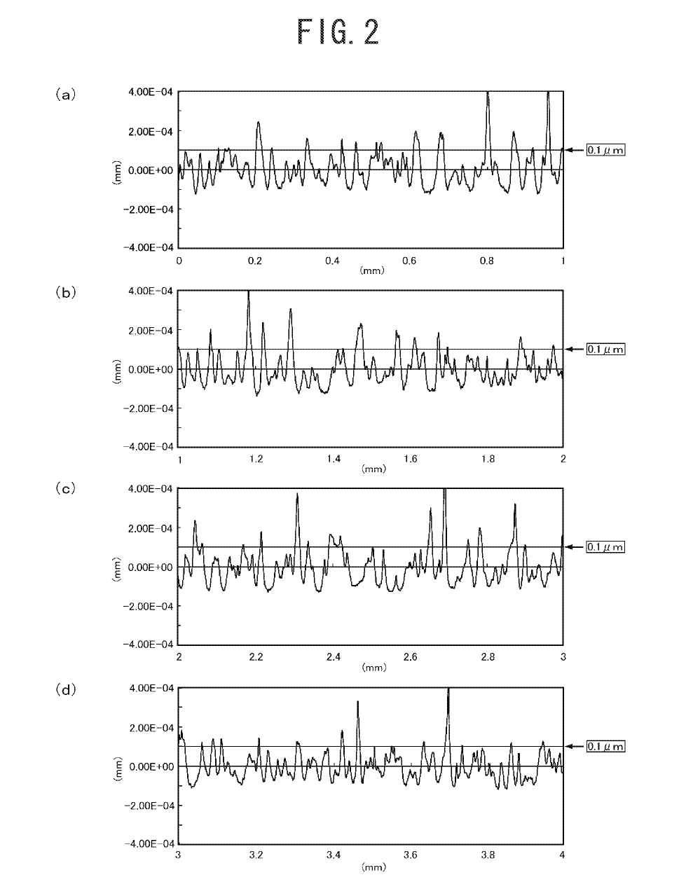

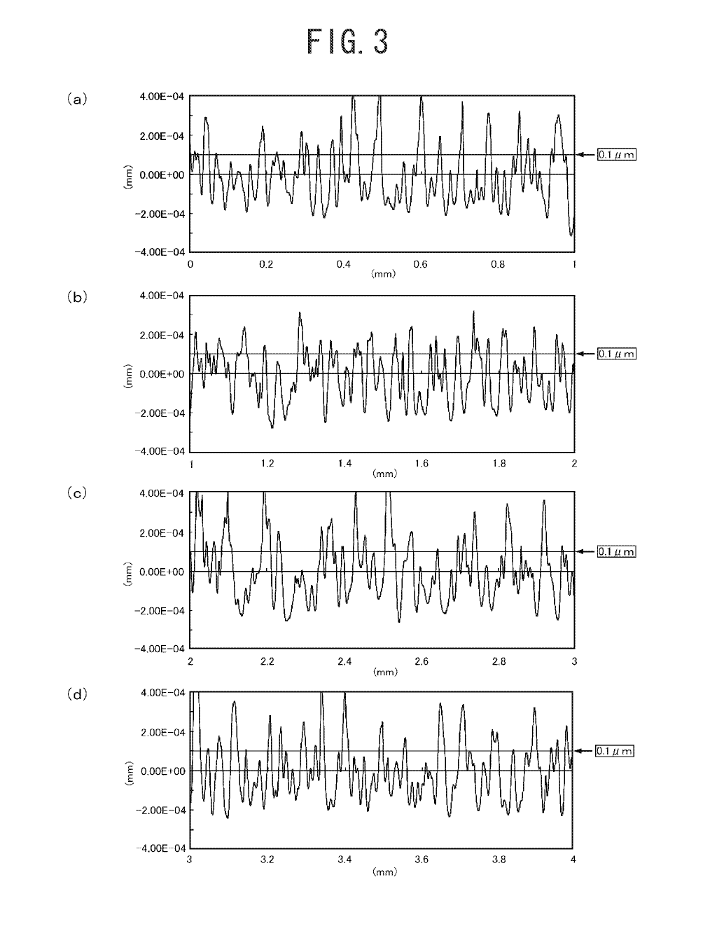

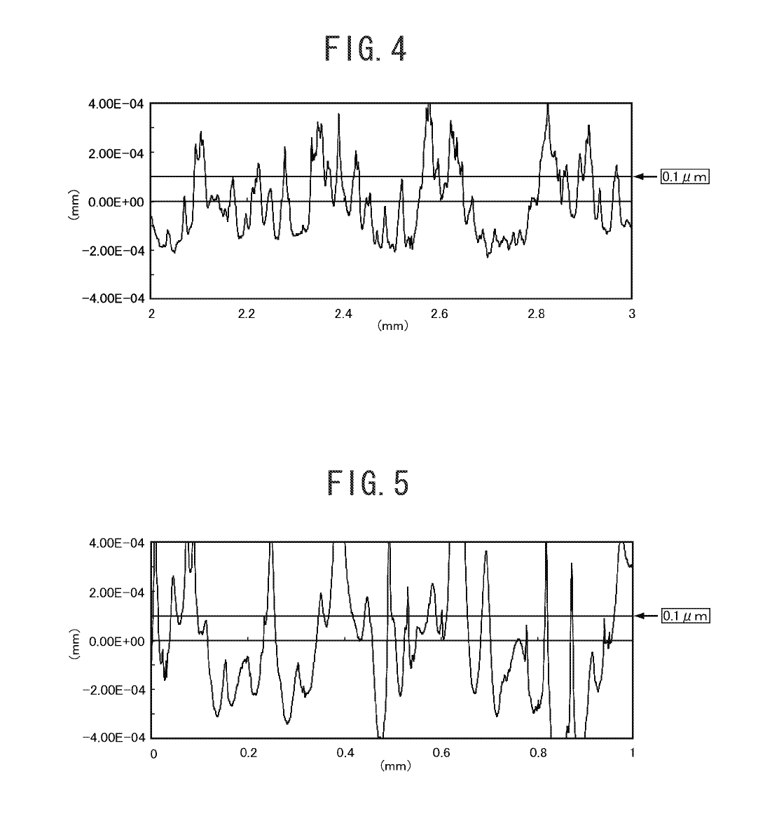

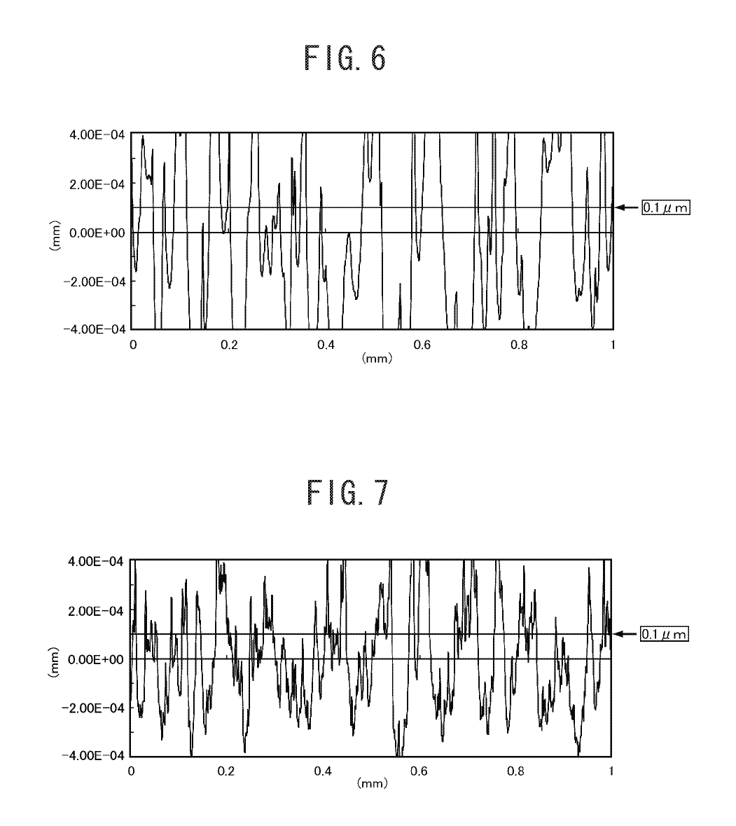

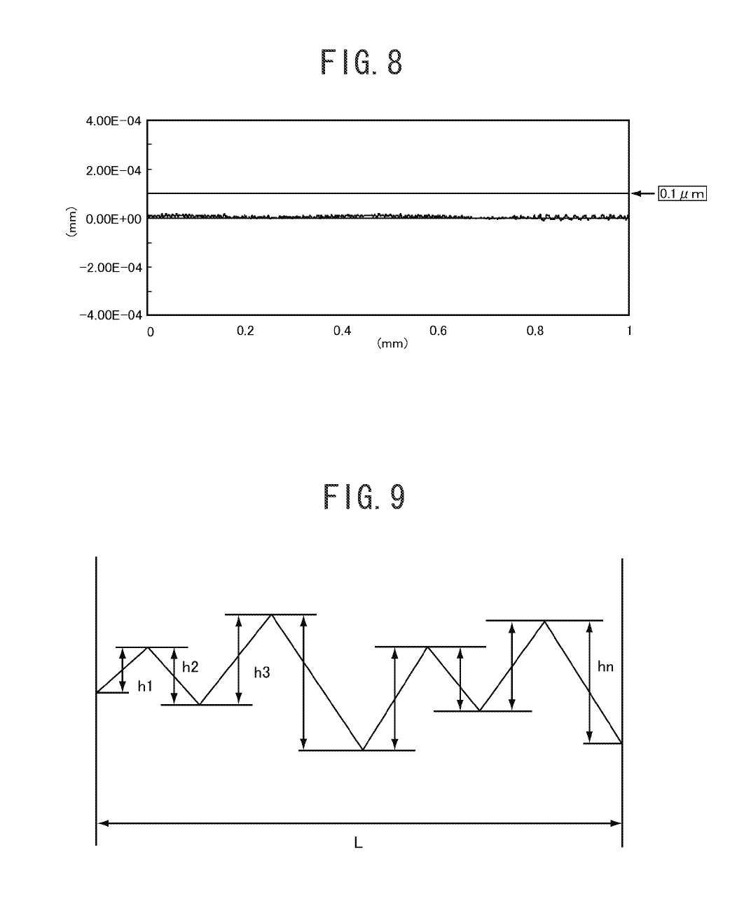

With respect to each hard-coated antiglare film of Examples 1 to 3 and Comparative Examples 1 to 4 and the low reflection hard-coated film of Comparative Example 5 thus obtained, various properties were measured or evaluated. The results are indicated in FIGS. 1 to 8 and Table 1 below.

TABLE 1

| | | | | | | | The number of | | | | | |
|---|---|---|---|---|---|---|---|---|---|---|---|---|
| | | | | | | | convexities | | | | | |
| | Thickness | | | | | The | (length of line | | | | | |
| | of | Reflection | | | | number | segment) | | Reflected | | | |
| | HC film | intensity | θa | Ra | Haze | of | 20 μm | 50 μm | hue | | Antiglare | |
| | (μm) | ratio | (° ) | (μm) | (%) | convexities | or less | or more | x | y | properties | Glare |
| Example 1 | 9 | 1.85 | 0.98 | 0.10 | 13 | 108 | 62 | 0 | 0.322 | 0.238 | A | A |
| Example 2 | 9 | 1.46 | 0.75 | 0.06 | 26 | 130 | 74 | 0 | 0.328 | 0.240 | A | AA |
| Example 3 | 9 | 1.67 | 1.28 | 0.12 | 25 | 131 | 52 | 0 | 0.308 | 0.233 | AA | AA |
| Comparative | 5 | 2.25 | 0.88 | 0.12 | 26 | 82 | 41 | 2 | 0.380 | 0.182 | A | A |
| Example 1 | | | | | | | | | | | | |
| Comparative | 5 | 3.27 | 1.59 | 0.24 | 8 | 60 | 33 | 6 | 0.242 | 0.126 | A | B |
| Example 2 | | | | | | | | | | | | |
| Comparative | 4 | 18.08 | 3.71 | 0.38 | 25 | 103 | 51 | 3 | 0.395 | 0.192 | AA | B |
| Example 3 | | | | | | | | | | | | |
| Comparative | 5 | 5.64 | 2.81 | 0.16 | 11 | 176 | 119 | 1 | 0.281 | 0.116 | A | B |
| Example 4 | | | | | | | | | | | | |
| Comparative | 5 | 0.29 | 0.15 | 0.00 | 0 | 0 | 0 | 0 | 0.318 | 0.287 | B | AA |
| Example 5 | | | | | | | | | | | | |

As shown in Table 1 above, the examples showed favorable results in all of reflection intensity, tinting, antiglare properties, and glare. Generally, when a hard-coating antiglare layer is subjected to a low reflection treatment, since tinting of diffusion light, which is caused by an antiglare layer, occurs, the entire hard-coating antiglare layer tends to be tinted. However, in these examples, there are antiglare properties in only the part to which light is applied, and the other parts look black. Thus, favorable properties were shown. On the other hand, the comparative examples showed favorable results in some of reflection intensity, tinting, antiglare properties, and glare, but not in all of them. That is, in Comparative Examples 1 to 4, since there are convexities with a length of the line segments of 50 μm or longer, and a reflected hue was out of the range satisfying 0.2≦y≦0.4, tinting was observed while antiglare properties were favorable. In Comparative Examples 2 to 4, it is presumed that θa exceeding 1.5 influences on glare properties. Further, the reflection intensity ratio exceeded 3. In Comparative Example 5, the θa was less than 0.5, the Ra was 0 μm, the number of convexities having the length of the line segments of 20 μm or shorter was 0, and there were no antiglare properties. By determining θa, Ra, and the number of convexities, which are defined in the present invention, it becomes possible to understand the tendency of visibility such as reflection intensity, tinting, antiglare properties, and glare without evaluating by visual observation.

FIGS. 1 to 8 show the profiles of the sectional surface shapes of the hard-coated antiglare films or the low reflection hard-coated film obtained in the aforementioned examples and comparative examples. As compared to the hard-coated antiglare films obtained in the comparative examples, each of the hard-coated antiglare films obtained in the examples is in a condition where the whole is not rough but fine concavities and convexities are present sparsely and further no local large convexities (with a length of the line segment of 50 μm or longer) exist. It can be understood that hard-coated antiglare films with surface unevenness shapes like those of the examples are within the range defined by the aforementioned θa, Ra, and the size and number of the convexities, and thereby can be used suitably as hard-coated antiglare films.

### INDUSTRIAL APPLICABILITY

Since the hard-coated antiglare film of the present invention is favorable in antiglare properties, and suppresses glare from occurring, and can lower a haze value while suppressing “tinting” occurred in the case of lowering reflection, visibility can be improved as compared with that of a conventional low reflection hard-coated antiglare film. Further, by preventing “tinting” from occurring, the depth of black in black display of an image display can be improved. Therefore, the hard-coated antiglare film of the present invention can be used, for example, preferably in optical elements such as polarizing plates, liquid crystal panels, and image displays such as LCDs and the use thereof is not limited, and it is applicable to the wide range of field. Further, by determining θa, Ra, and the size and the number of convexities, it becomes possible to understand tendencies of reflection intensity, tinting, antiglare properties, glare, which are defined in the present invention without evaluating by visual observation. It is effective as an indicator for evaluation of antiglare film.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A hard-coated antiglare film having a reflection intensity ratio of 3 or less, comprising:
a transparent plastic film substrate;
a hard-coating antiglare layer; and
an antireflection layer, the hard-coating antiglare layer and the antireflection layer being on at least one surface of the transparent plastic film substrate, wherein
the hard-coating antiglare layer contains fine particles,
a surface of the antireflection layer has: an uneven shape; an average angle of inclination θa satisfying 0.5≦θa≦1.5; and a following arithmetic average surface roughness Ra in a range of 0.05 to 0.15 μm, and
the hard-coated antiglare film includes: at least 80 convexities that exceed a roughness mean line of a surface roughness profile in a 4-mm long portion at an arbitrary location of the surface of the antireflection layer; convexities that exceed a standard line that is in parallel with the roughness mean line and is located at a height of 0.1 μm; and no convexities in which line segments of portions of the standard line that cross the convexities each have a length of 50 μm or longer,
Reflection intensity ratio:a ratio of a reflection intensity obtained when light is applied to the hard-coated antiglare film at an angle of 10° with a direction perpendicular to the hard-coated antiglare film so that a light intensity of the topmost surface of the hard-coated antiglare film becomes 1000 Lx assuming that a reflection intensity of a hard-coated film with a refractive index of 1.53 is 1,
Ra: an arithmetic average surface roughness (μm) that is defined in JIS B 0601 (1994 version).

2. The hard-coated antiglare film according to claim 1, wherein the antireflection layer has a thickness in a range of 170 to 350 nm.

3. The hard-coated antiglare film according to claim 1, wherein a haze value is in a range of 4 to 30.

4. The hard-coated antiglare film according to claim 1, wherein
the hard-coating antiglare layer is formed using the fine particles and a material for forming a hard-coating layer, which contains following components (A) and (B):
the component (A): a curable compound having at least one of an acrylate group and a methacrylate group; and
the component (B): particles with a weight average particle size of 200 nm or shorter, which are formed by binding between inorganic oxide particles and an organic compound having a polymerizable unsaturated group.

5. The hard-coated antiglare film according to claim 4, wherein in the component (B), the inorganic oxide particles include particles of at least one type selected from the group consisting of silicon oxide, titanium oxide, aluminum oxide, zinc oxide, tin oxide, and zirconium oxide.

6. The hard-coated antiglare film according to claim 4, wherein the material for forming a hard-coating layer contains the component (B) in a range of 100 to 200 parts by weight per 100 parts by weight of the component (A).

7. The hard-coated antiglare film according to claim 1, wherein
a difference in refractive index between the material for forming a hard-coating layer and the fine particles is in a range of 0.01 to 0.04,
the hard-coated antiglare film contains, as the fine particles, at least one type of spherical and amorphous fine particles, each of which have a weight average particle size in a range of 0.5 to 8 μm, and
the hard-coated antiglare film contains the fine particles in a range of 5 to 20 parts by weight per 100 parts by weight of the material for forming a hard-coating layer.

8. The hard-coated antiglare film according to claim 1, wherein the hard-coating antiglare layer has a thickness in a range that is 1.2 to 3 times the weight average particle size of the fine particles.

9. A polarizing plate, comprising:
the hard-coated antiglare film according to claim 1; and
a polarizer.

10. An image display, comprising:
the hard-coated antiglare film according to claim 1.

11. An image display, comprising:
the polarizing plate according to claim 9.

12. A method for evaluating a hard-coated antiglare film, comprising:
evaluating visibility of a hard-coated antiglare film using:
a following reflection intensity ratio;
an average angle of inclination θa of an uneven shape on a surface of the hard-coated antiglare film;
a following arithmetic average surface roughness Ra;
the number of convexities that exceed a roughness mean line of a surface roughness profile in a 4-mm long portion at an arbitrary location of the surface of the hard-coated antiglare film; and
a size and the number of convexities that exceed a standard line that is in parallel with the roughness mean line and is located at a height of 0.1 μm,
Reflection intensity ratio:a ratio of a reflection intensity obtained when light is applied to the hard-coated antiglare film at an angle of 10° with a direction perpendicular to the hard-coated antiglare film so that a light intensity of the topmost surface of the hard-coated antiglare film becomes 1000 Lx assuming that a reflection intensity of a hard-coated film with a refractive index of 1.53 is 1,
Ra: an arithmetic average surface roughness (μm) that is defined in JIS B 0601 (1994 version).

13. The method according to claim 12, wherein
the hard-coated antiglare film is evaluated as acceptable when the reflection intensity ratio is 3 or less, the θa satisfies 0.5≦θa≦1.5, the Ra is in a range of 0.05 to 0.15 μm, and the hard-coated antiglare film includes at least 80 convexities that exceed the roughness mean line and no convexities in which line segments of portions of the standard line that cross the convexities each have a length of 50 μm or longer.

14. The method according to claim 12, comprising:
further evaluating visibility of the hard-coated antiglare film using a haze value of the hard-coated antiglare film.

15. The method according to claim 14, wherein
when the haze value is in a range of 4 to 30, the hard-coated antiglare film is evaluated as acceptable.
